(19) United States
(12) Patent Application Publication
(10) Pub. No.: US 2003/0051122 A1
(43) Pub. Date: Mar. 13, 2003

(54) Trace information generation apparatus for generating branch trace information omitting at least part of branch source information and branch destination information on target processing

(75) Inventor: Hisakazu Sato, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 10/214,231

(22) Filed: Aug. 8, 2002

(30) Foreign Application Priority Data
Sep. 10, 2001 (JP) 2001-273413(P)

(51) Int. Cl. G06F 9/00

(52) U.S. Cl. 712/227

(57) ABSTRACT

A branch trace information generation unit generates branch trace information omitting at least part of branch source information and branch destination information on a target processing based on instruction execution information showing an instruction execution status of an instruction execution unit. A trace information output unit generates and outputs trace information capable of restoring an instruction executed by the instruction execution unit from the branch trace information generated by the branch trace information generation unit. It is, therefore, possible to reduce data amount of trace information.

### BACKGROUND OF THE INVENTION

1. Field of the Invention

The present invention relates to a technique for generating debugging information used for debugging a hardware on which a CPU (Central Processing Unit) is mounted or debugging a software, and particularly relates to a trace information generation apparatus for tracing a PC (Program Counter) value for restoring executed instructions and an execution order, generating trace information for observing the execution status of noted operand access and outputting the trace information.

2. Description of the Background Art

In recent years, CPU's are widely employed in information equipment such as personal computers, electric home appliances and the like. In the development of CPU's themselves or information equipment, electric home appliances or the like on which the CPU's are mounted, respectively, a debugging device is employed to debug a hardware or a software.

Further, demand for the acceleration of the processing speed of the CPU rises, and the operation frequency of the CPU tends to be increasingly higher to meet this demand, which operation frequency is far higher than the operation frequencies of external circuits provided externally of the CPU.

However, each conventional debugging device is required to output data to restore instructions executed by the CPU and the order of executing these instructions, with the result that the amount of data is considerably large as compared with the operation frequency of the CPU. To output such a large amount of data, many output pins are required, which disadvantageously pushes up cost.

Furthermore, to perform detailed debugging, it is desirable to be able to observe the execution status of operand access simultaneously with the debugging. To do so, the above-stated disadvantage becomes tougher.

### SUMMARY OF THE INVENTION

It is an object of the present invention to provide a trace information generation apparatus capable of reducing the data amount of trace information.

It is another object of the present invention to provide a trace information generation apparatus capable of correctly restoring the instruction execution of a processor.

It is yet another object of the present invention to provide a trace information generation apparatus capable of specifying which instruction in a program executes access to a noted operand.

According to a certain aspect of the present invention, a trace information generation apparatus includes: a branch trace information generation unit generating branch trace information omitting at least part of branch source information and branch destination information on a target processing based on instruction execution information showing an instruction execution status of a processor; and a trace information output unit generating and outputting trace information capable of restoring an instruction executed by the processor from the branch trace information generated by the branch trace information generation unit.

Since the branch trace information generation unit generates the branch trace information omitting at least part of the branch source information and the branch destination information on the target processing, it is possible to reduce the data amount of trace information.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the schematic configuration of a debugging device in a first embodiment according to the present invention;

FIGS. 2A to 2F are explanatory views for the data formats of trace information packets;

FIG. 3 shows examples of packet identification bits;

FIGS. 4A and 4B show examples of auxiliary FM codes;

FIG. 5 shows examples of access information;

FIG. 6 is a block diagram showing the schematic configuration of an instruction execution unit 6 in the first embodiment according to the present invention;

FIGS. 7A to 7D are explanatory views for the pipeline processing of a CPU 61 in the first embodiment according to the present invention;

FIG. 8 is a block diagram showing the schematic configuration of a branch trace information generation unit 2;

FIG. 9 is a block diagram showing the schematic configuration of a branch trace information output unit 26;

FIG. 10 is a timing chart for the timing of each signal in branch trace information generation unit 2 when ordinary instructions are executed;

FIG. 11 is a timing chart for the timing of each signal in branch trace information generation unit 2 when EIT is accepted;

FIG. 12 is a block diagram showing the schematic configuration of a data trace information generation unit 3; and

FIG. 13 is a block diagram showing the schematic configuration of a trace information output unit 5.

### DESCRIPTION OF THE PREFERRED EMBODIMENTS

(First Embodiment)

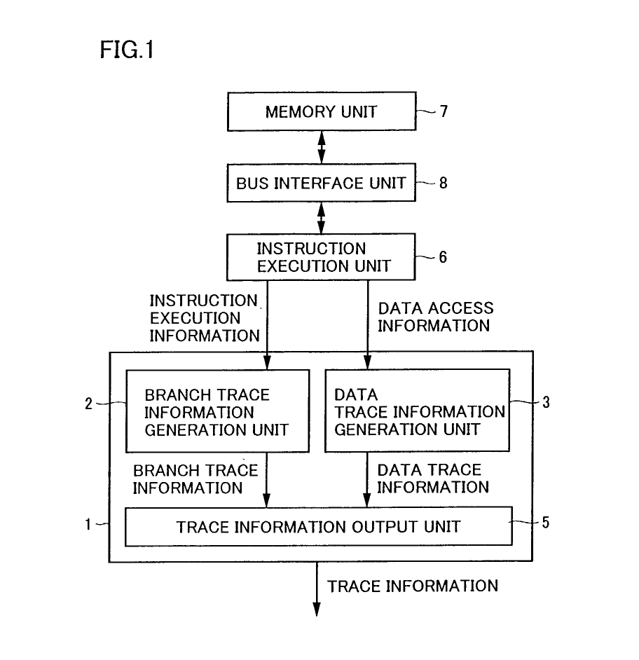

FIG. 1 is a block diagram showing the schematic configuration of a debugging device in a first embodiment according to the present invention. This debugging device includes a trace information generation unit 1 generating trace information necessary for debugging, an instruction execution unit 6 executing instructions and thereby outputting instruction execution information and data access information to be described later, a memory unit 7 storing debug target software or the like executed by instruction execution unit 6, and a bus interface unit 8 arbitrating access requests from instruction execution unit 6 and a DMA (Direct Memory Access) controller, not shown, and executing access to memory unit 7.

As will be described later, instruction execution unit 6 includes a general CPU, executes a processing in accordance with an instruction fetched from memory unit 7 and, if necessary, reads and writes data from and to memory unit 7. The instruction set of instruction execution unit 6 consists of two types of formats of two or four bytes. The basic data length of instruction execution unit 6 is 32 bits. Since the length of an address is 32 bits, as well, instruction execution unit 6 has an address space of 4 gigabytes. Instruction execution unit 6 also has a cache memory as will be described later.

Memory unit 7 consists of an SRAM (Static Random Access Memory), a DRAM (Dynamic Random Access Memory), a flash memory or the like and stores instructions executed by instruction execution unit 6 and data used for the execution of the instructions. In some cases, memory unit 7 includes input-output devices such as an A/D (Analog/Digital) converter and a D/A (Digital/Analog) converter.

Trace information generation unit 1 generates trace information based on the instruction execution information and the data access information outputted from instruction execution unit 6 and outputs the generated trace information. This trace information generation unit 1 includes a branch trace information generation unit 2, a data trace information generation unit 3 and a trace information output unit 5.

Branch trace information generation unit 2 generates branch trace information for tracing the instruction executed by instruction execution unit 6 based on the instruction execution information outputted from instruction execution unit 6.

Data trace information generation unit 3 generates data trace information for tracing data access executed by instruction execution unit 6 to memory unit 7 based on the data access information outputted from instruction execution unit 6. It is noted that data trace information generation unit 3 also generates and outputs data trace information for tracing data access to the cache memory provided in instruction execution unit 6 as well as data access executed by instruction execution unit 6 to memory unit 7.

Trace information output unit 5 generates trace information based on the branch trace information outputted from branch trace information generation unit 2 and the data trace information outputted from data trace information generation unit 3. The trace information outputted from trace information output unit 5 is stored in an external trace memory, not shown, and read by a computer such as an ICE (In-Circuit Emulator), not shown, whereby the execution status of instruction execution unit 6 is restored and analyzed.

The trace information outputted from trace information generation unit 1 in this embodiment is generated in a packet form. The packet of the trace information will be referred to as “trace information packet” hereinafter.

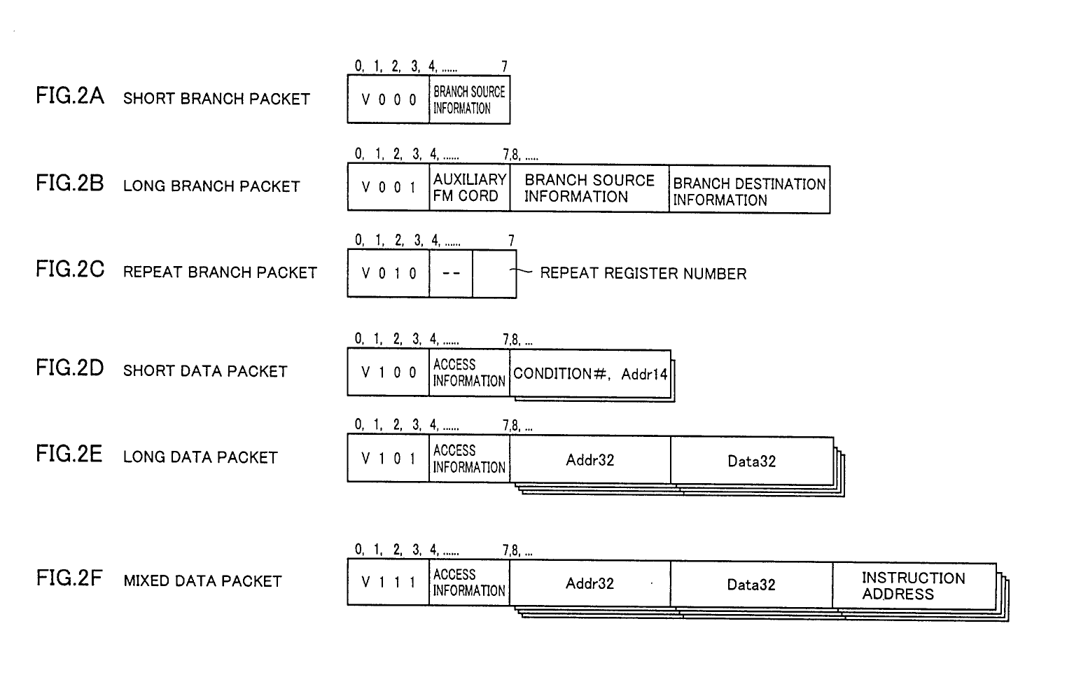

FIGS. 2A to 2F are explanatory views for the data formats of trace information packets. The trace information packets are roughly classified into branch packets and data packets. The branch packets involve a short branch packet, a long branch packet and a repeat branch packet shown in FIGS. 2A to 2C. The data packets involve a short data packet, a long data packet and a mixed data packet shown in FIGS. 2D to 2F.

In each packet format, an overflow flag, to be described later, is allocated to bit [0] to show whether or not there is trace information lost by input overflow before the output of the packet. Packet identification bits showing the type of the packet format are allocated to bits [1:3]. It is noted that bits [1:3] represent bit [1] to bit [3].

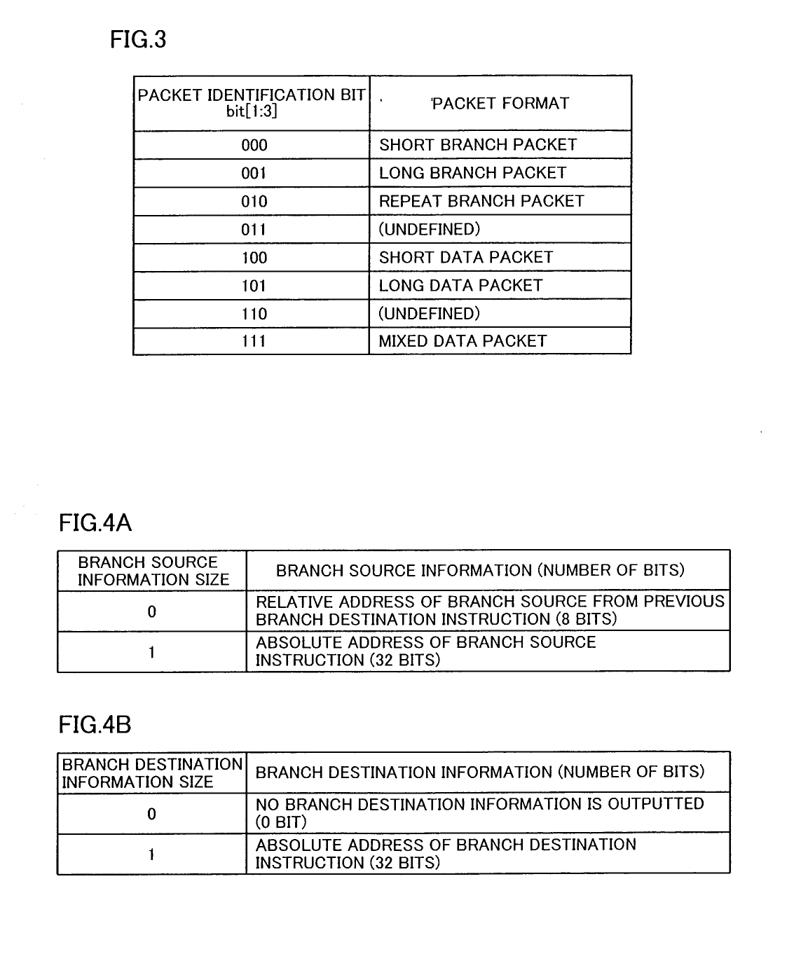

FIG. 3 shows examples of packet identification bits. If packet identification bits [1:3] are “000”, this indicates that the packet is a short branch packet. If bits [1:3] are “001”, this indicates that the packet is a long branch packet. If bits [1:3] are “010”, this indicates that the packet is a repeat branch packet.

If packet identification bits [1:3] are “100”, this indicates that the packet is a short data packet. If packet identification bits [1:3] are “101”, this indicates that the packet is a long data packet. If packet identification bits [1:3] are “111”, this indicates that the packet is a mixed data packet. While the format of a packet that packet identification bits [1:3] are “011” or “110” is undefined, a packet in the other data format may be appropriately allocated.

Description will be given again to the packet formats shown in FIGS. 2A to 2F. A branch packet is a packet generated based on the branch trace information outputted from branch trace information generation unit 2 and used to trace the instruction executed by instruction execution unit 6 as will be described later.

Instruction execution unit 6 continues to execute sequential instructions in turn unless a jump instruction is executed or an interrupt occurs. Accordingly, all the executed instructions can be grasped if an instruction (to be referred to as “branch source instruction” hereinafter) executed just before the execution of a branch instruction or the occurrence of an interrupt (to be referred to as “occurrence of a sequence change” hereinafter) and an instruction (to be referred to as “branch destination instruction” hereinafter) executed just after the occurrence of the sequence change can be specified. This is because instructions sequentially arranged between the occurrence of a sequence change and the occurrence of the next sequence change are executed since the occurrence of a sequence change until the occurrence of the next sequence change. A branch packet is outputted whenever a sequence change occurs and the branch packet includes branch source information for specifying the branch source instruction and branch destination information for specifying the branch destination instruction.

The short branch packet shown in FIG. 2A includes only branch source information of four bits. This branch source information of four bits designates the branch source instruction by a relative address from the branch source instruction designated by a branch packet outputted just before the short branch packet. This short branch packet does not include branch destination information. The reason is as follows. If a branch destination is explicitly shown in a program and the program is stored in ROM, for example, a branch destination instruction is uniquely determined when instruction trace is performed. The branch destination information is, therefore, omitted so as to reduce the amount of information.

The long branch packet shown in FIG. 2B includes branch source information of eight or 32 bits, branch destination information of 0 or 32 bits, and an auxiliary format code (to be referred to as “auxiliary FM code” hereinafter) of four bits showing the number of bits of each of the two pieces of information.

If the number of bits of the branch source information is eight, the less significant four bits thereof store a relative address designating the branch source instruction as in the case of the short branch packet and the remaining four bits are subjected to zero expansion. If the length of the branch source information is 32, an absolute address of 32 bits designating the branch source instruction is stored.

That the length of the branch destination information is 0 corresponds to a case of omitting the branch destination information so as to reduce the amount of information if the branch destination instruction is uniquely determined as in the case of the short branch packet. If the length of the branch destination information is 32, an absolute address of 32 bits is stored.

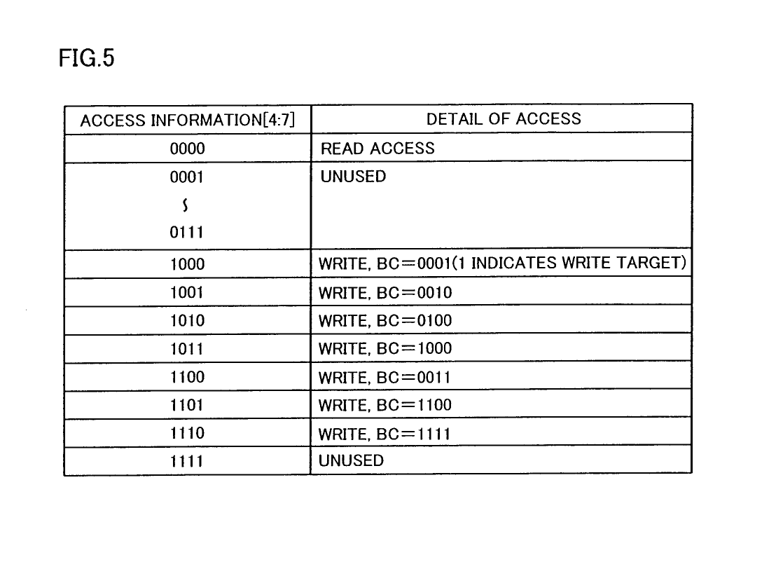

FIGS. 4A and 4B show examples of auxiliary FM codes. Each auxiliary FM code includes a branch source information size of one bit showing the number of bits of the branch source information, a branch destination information size of one bit showing the number of bits of the branch destination information, and a repeat register number of two bits.

As shown in FIG. 4A, if the branch source information size is “0”, this indicates that the number of bits of the branch source information is eight and that a relative address to the branch destination instruction designated by a previous branch packet is stored in the branch source information. If the branch source information size is “1”, this indicates that the number of bits of the branch source information is 32 and that an absolute address of 32 bits designating the branch source instruction is stored in the branch source information.

As shown in FIG. 4B, if the branch destination information size is “0”, this indicates that the branch destination information is omitted. If the branch destination information size is “1”, this indicates that the number of bits of the branch destination information is 32 and that an absolute address of 32 bits designating the branch destination instruction is stored in the branch destination information.

Description will be given again to the packet format shown in FIG. 2B. A repeat register number included in the auxiliary FM code is always allocated to the long branch packet and referred to by the repeat branch packet to be described next. The generation of this repeat register number will be described later.

The repeat branch packet shown in FIG. 2C includes unused two bits and a repeat register number of two bits. This repeat branch packet has the same repeat register number as that included in the auxiliary FM code and shows that a sequence change same in content as the latest outputted long branch packet. The branch source information and the branch destination information are not, therefore, included in this repeat branch packet.

The data packet is generated based on the data trace information outputted from data trace information generation unit 3 and outputted if operand access executed by instruction execution unit 6 to the memory space coincides with preset conditions. This operand access includes access to input-output devices and that to the cache memory but does not include the fetching of an instruction.

The short data packet shown in FIG. 2D includes access information of four bits, a condition cluster number (condition #) of two bits and address information of 14 bits (Addr14). The access information shows whether the operand access coincident with the present condition is read or write access and to which byte data is written if the operand access is write access.

FIG. 5 shows examples of access information. If access information [4:7] is “0000”, this indicates that the operand access is read access. The access information [4:7] of “0001” to “0111” are unused.

If the access information [4] is “1”, this indicates that the operand access is write access. The access information [5:7] shows to which byte(s) data is written. If the access information [5:7] is “000”, for example, this indicates write access only to the least significant one byte among the four bytes. BC (byte control) shows to which byte(s) data is written and shows that data is written to a byte corresponding to “1”. It is noted that access information [4:7] of “1111” is unused.

Description will be given again to the packet format shown in FIG. 2D. The condition cluster number indicates that with which condition among a plurality of designated conditions this data packet coincides. The address information shows the less significant 14 bits of the address of the operand access coincident with the condition.

The long data packet shown in FIG. 2E includes access information of four bits, address information of 32 bits (Addr32), and data information of 32 bits (Data32). The access information is the same as that included in the short data packet. The address information of 32 bits shows the address of the operand access coincident with the condition. The data information of 32 bits shows data on the operand access coincident with the condition.

The mixed data packet shown in FIG. 2F includes access information of four bits, address information of 32 bits (Addr32), data information of 32 bits (Data32) and instruction address information of 32 bits. The access information, the address information and the data information are the same as those included in the long data packet. The instruction address information shows the absolute address of an instruction executing the operand access coincident with the condition.

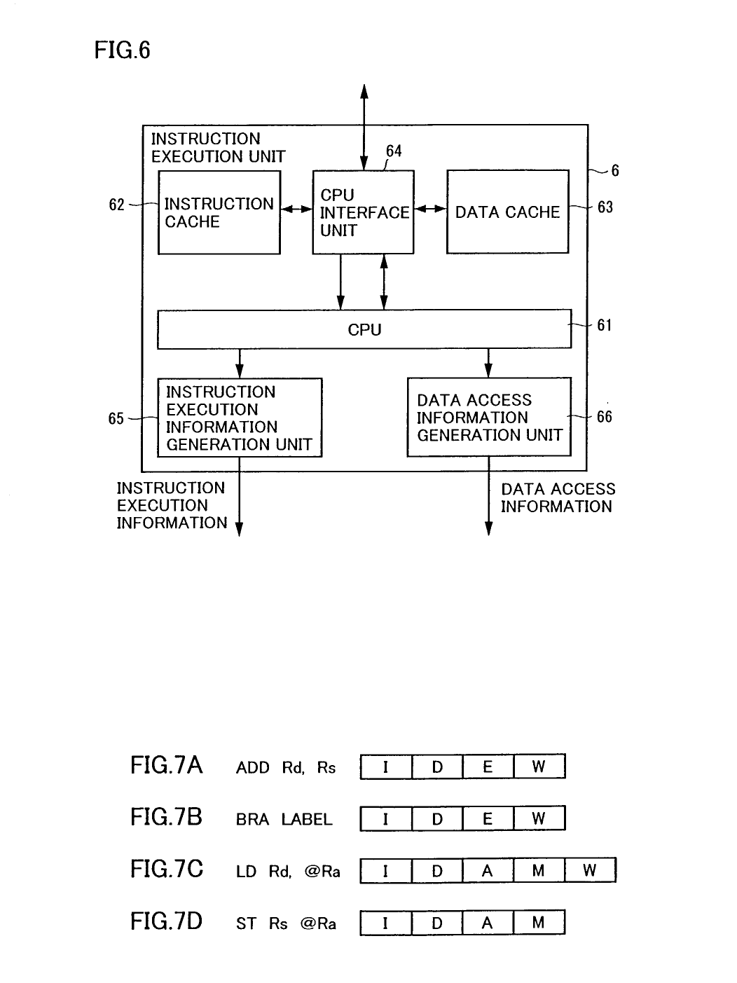

FIG. 6 is a block diagram showing the schematic configuration of instruction execution unit 6 in the first embodiment according to the present invention. This instruction execution information 6 includes a CPU 61 executing an instruction fetched from memory unit 7, an instruction cache 62, a data cache 63, a CPU interface unit 64 accessing memory unit 7, instruction cache 62 or data cache 63 in response to an access request from CPU 61, an instruction execution information generation unit 65 monitoring the instruction execution status of CPU 61 and generating and outputting instruction execution information, and a data access information generation unit 66 monitoring the operand access status of CPU 61 and generating and outputting data access information.

CPU 61 consists of a general microprocessor and executes processings including an arithmetic operation processing, a logical operation processing and a branch processing. CPU 61 also executes a load processing for reading data from memory unit 7 and a store processing for writing data to memory unit 7. These load processing, store processing and an instruction fetch processing are carried out through CPU interface unit 64. Since the load processing and the store processing conducted to memory unit 7 normally require many clock cycles, instruction cache 62 and data cache 63 are provided in instruction execution unit 6 so as to efficiently perform the processings. Since the operation of instruction cache 62 and that of data cache 63 are normal, no detailed description will be given thereto.

The instruction executed by CPU 61 includes two types of formats of two bytes or four bytes. In this embodiment, a unified memory type in which an instruction and data are arranged in the same address space is shown and the address space of 32 bits are provided. However, the present invention is not limited thereto. In addition, it is assumed that instruction execution follows a pipeline system so as to improve throughput.

FIGS. 7A to 7D are explanatory views for the pipeline processing of CPU 61 in the first embodiment according to the present invention. The outline of each pipeline stage will be described first.

In an instruction fetch (I) stage, an instruction is fetched from memory unit 7 or instruction cache 62. If an instruction is fetched from a memory having low access speed such as a case of fetching an instruction stored in memory unit 7, it sometimes takes a plurality of cycles.

In an instruction decode (D) stage, the instruction fetched in the I stage is decoded and the type of the instruction is determined, thereby preparing for the execution of the instruction.

In an instruction execution (E) stage, processings such as arithmetic operation and data transfer are executed in accordance with a decoding result in the D stage. In this embodiment, it is assumed that the start of instruction execution signifies the start of processings in the E stage and those in an A stage to be described next.

An address calculation (A) stage is executed in place of the E stage if a load instruction, a store instruction or the like is issued. In the A stage, store data, load data, an access address, a byte control signal and an access mode signal are generated.

A memory access (M) stage is executed only in response to the load instruction or the store instruction. In the M stage, operand access to memory unit 7 or data cache 63 is performed. If a memory having a low access speed is accessed such as memory unit 7, it sometimes takes a plurality of cycles.

In a writeback (W) stage, an operation result, a transfer result or data read by a load instruction is stored in a predetermined register. In case of a subroutine call, the address of a return destination instruction is stored in a link register.

FIG. 7A shows the pipeline processing for an ADD instruction. The ADD instruction includes four pipeline stages (I, D, E and W). In this ADD instruction, the value of a register Rd and that of a register Rs are added together and the addition result is stored in register Rd. The other instructions such as an arithmetic operation instruction, a logical operation instruction and an internal register transfer instruction are executed according to the same pipeline.

FIG. 7B shows the pipeline processing for a BRA instruction. As in the case of the ADD instruction, the BRA instruction includes four pipeline stages (I, D, E and W). In this BRA instruction, the execution of a program is moved to an instruction at an address denoted by Label. The I stage of the instruction denoted by Label is started while overlapping with the W stage of the BRA instruction.

FIG. 7C shows the pipeline processing for an LD instruction. This LD instruction includes five pipeline stages (I, D, A, M and W). In this LD instruction, data of 32 bits is read from the memory with the value of a register Ra as an address and the data thus read is stored in register Rd. Beside this LD instruction, instructions (LDH, LDUH, LDB, LDUB) for loading data of 16 bits or data of 8 bits are prepared and executed according to the same pipeline.

FIG. 7D shows the pipeline processing for an ST instruction. This ST instruction includes four pipeline stages (I, D, A and M). In this ST instruction, data of 32 bits is written to the memory with the value of register Ra as an address. The data to be written is stored in register Rs. Beside this ST instruction, instructions (STH, STB) for writing data of 16 bits and data of eight bits are prepared and executed according to the same pipeline.

CPU 61 has a store data signal, a load data signal, an access address signal, a pipeline control signal and an access mode signal as signals generated when the above-stated load instruction and store instruction are executed. CPU interface unit 64 generates a control signal for memory unit 7 or data cache unit 63 using these signals and executes data access.

The store data is data bus of 32 bits for outputting data to be stored in the memory. If the length of write data is eight or 16 bits, valid data is outputted only to the position of bits corresponding to the byte control signal.

The load data is a data bus of 32 bits for receiving data read from the memory.

The access address is an address bus for outputting an address designating data of 32 bits to be accessed.

The byte control signal is a signal showing the position of a byte to be accessed among the 32-bit data designated by the access address. In case of 4-byte access, 2-byte access, and 1-byte access, the byte control is outputted so that all four bytes are to be accessed, only two bytes are to be accessed or only one byte is to be accessed, respectively.

The access mode signal is a signal showing whether access is read access or write access.

Instruction execution information generation unit 65 monitors the instruction execution status of CPU 61 and generates instruction execution information outputted to branch trace information generation unit 2. The instruction execution information generated by instruction execution information generation unit 65 includes an instruction execution start signal, an execution instruction address, an execution instruction size signal, a sequence change signal and a direct branch signal.

The instruction execution start signal shows that CPU 61 starts executing a new instruction and asserted in the next cycle to a cycle in which the E stage or A stage of the new instruction starts a processing. Instruction execution information generation unit 65 can easily generate the instruction execution start signal by referring to the pipeline control signal of CPU 61.

The execution instruction address is generated simultaneously with the instruction execution start signal and shows the address of an instruction that the execution of which is started by CPU 61 by 32 bits. This execution instruction address holds the address value of the last executed instruction until the execution of the next instruction is started. CPU 61 holds an instruction address value designating the instruction which is being executed in the E stage or A stage so as to specify a return destination instruction from an interrupt or an instruction causing an exception or to calculate the address of a PC relative jump. Accordingly, instruction execution information generation unit 65 can easily output this execution instruction address when the instruction execution start address is asserted.

The execution instruction size signal is a signal generated simultaneously with the instruction execution start signal and shows the size of an instruction that the execution of which is started by CPU 61. If the execution instruction size signal is “0”, this indicates that the size of the instruction is two bytes. Also, if the execution instruction size signal is “1”, this indicates that the size of the instruction is four bytes. When decoding an instruction, CPU 61 generates a signal indicating whether the size of the instruction is two bytes or four bytes. Accordingly, instruction execution information generation unit 65 can generate the execution instruction size signal by holding this signal and outputting the signal at the same timing as the output of the instruction execution start signal.

The sequence change signal is a signal showing that CPU 61 executes a processing involving an instruction sequence change. There are two types of factors for causing the sequence change in CPU 61. The first type of factors involve instructions explicitly changing a program execution sequence such as the execution of a jump instruction, a subroutine call instruction and a return instruction from an EIT processing to be described later. These instructions will be generally referred to as “branch instructions”. The sequence change signal is asserted only if a branch processing is actually executed. If no conditions are satisfied in a condition jump instruction, the sequence change signal is not asserted.

The second type of factors involve the occurrence of an exception and an interrupt and the execution of a trap instruction used in an OS (Operating system) or the like. These factors will be generally referred to as “EIT”. The EIT is accepted through three cycles of detection, determination and execution. In the detection cycle, CPU 61 detects that there is an acceptable EIT request and does not start executing a new instruction after detecting the acceptable EIT. In the determination cycle, if a plurality of EIT request are detected, it is determined which request is to be accepted in accordance with a priority. In the execution cycle, CPU 61 executes a jump to an instruction address corresponding to the accepted EIT. This execution corresponds to a processing carried out in the E stage of the branch instruction.

CPU 61 outputs a signal showing the start of the execution of the branch instruction, a signal showing whether or not branch conditions are satisfied, and a signal showing an EIT execution cycle. Instruction execution information generation unit 65 generates a sequence change signal based on these signals. The sequence change signal is outputted at the timing of the W stage in case of the branch instruction or the timing of the next cycle to the EIT execution cycle in case of EIT.

The direct branch signal is a signal showing whether or not the sequence change which occurs in CPU 61 is caused by a branch instruction explicitly showing a branch destination as immediate data in a program (which branch instruction will be referred to as “direct branch” instruction hereinafter). If the direct branch is executed, an direct branch signal is asserted simultaneously with the sequence change signal. When a branch (indirect branch) instruction having a branch destination stored in a register is executed or an EIT request occurs, this direct branch signal is not asserted. This is because a branch destination instruction cannot be specified when the program is generated in these cases. Instruction execution information generation unit 65 can generate this direct branch signal by referring to the decoding result of CPU 61.

Data access information generation unit 66 monitors the load instruction processing and the store instruction processing of CPU 61, generates data access information and outputs the generated data access information to data trace information generation unit 3. The data access information includes an access address, access data, an access mode signal, a byte control signal and a target instruction address. These signals are generated in the next cycle (e.g., W stage in case of the load instruction) to a cycle in which the M stage of the load instruction or the store instruction is completed.

The access address is an address showing in which 32-bit data boundary data to be accessed in response to the load instruction or the store instruction is included. Data access information generation unit 66 holds an address generated by CPU 61 in the A stage and outputs the held address in the next cycle (W stage) to the M stage.

The access data shows data of 32 bits read by the load instruction or data of 32 bits written by the store instruction. In case of the store instruction, data access information generation unit 66 holds the store data generated by CPU 61 in the A stage and outputs the held store data in the next cycle (W stage) to the M stage. In case of the load instruction, data access information generation unit 66 outputs data which CPU 61 is to write to a register in the W stage as access data.

The access mode signal is a signal showing whether an instruction is a load instruction or a store instruction. Data access information generation unit 66 holds the access mode signal generated by CPU 61 in the A stage and outputs the held access mode signal in the next cycle (W stage) to the M stage.

The byte control signal is a signal showing the size of data to be read or written and a byte position. Data access information generation unit 66 holds the byte control signal generated by CPU 61 in the A stage and outputs the held byte control signal in the next cycle (W stage) to the M stage.

The target instruction address shows the instruction address of the load instruction or the store instruction causing memory access. Data access information generation unit 66 holds the instruction address held by CPU 61 in the A stage and outputs the held instruction address in the next cycle (W stage) to the M stage.

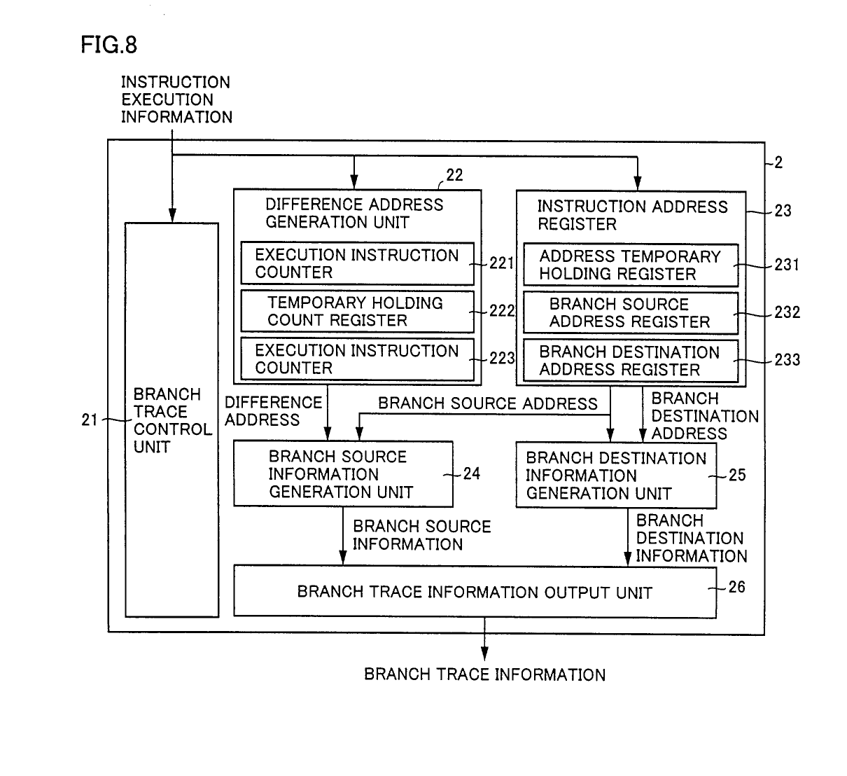

FIG. 8 is a block diagram showing the schematic configuration of branch trace information generation unit 2. This branch trace information generation unit 2 includes a branch trace control unit 21 controlling overall branch trace information generation unit 2, a difference address generation unit 22, an instruction address register 23, a branch source information generation unit 24 generating branch source information when a sequence change occurs, a branch destination information generation unit 25 generating branch destination information when a sequence change occurs, and a branch trace information output unit 26 generating branch trace information from the branch source information and the branch destination information and outputting the generated branch trace information.

Branch trace control unit 21 controls the operation of overall branch trace information generation unit 2 based on the value of a control register, not shown, and the value of instruction execution information. The control register includes a branch trace enable register, a branch destination information mode register and an absolute information mode register. External equipment can access these registers through a JTAG (Joint Test Action Group) provided in branch trace information generation unit 2.

The branch trace enable register is a register for designating whether or not branch trace information is generated and this register can designate three states; i.e., a branch trace enable state, an auxiliary trace enable state and a branch trace disable state. If the branch trace disable state is designated, branch trace information generation unit 2 does not at all perform any operation.

If the branch source instruction is included in a specific address range, it is possible to generate branch destination information using an absolute address even during direct branch. The branch destination information mode register includes a field designating whether such a function is validated or invalidated and a field designating the upper and lower limits of the specific address range if this function is valid.

The absolute information mode register includes a field designating whether a function of generating the branch source information and the branch destination information by using the absolute addresses, respectively, once for N times is to be validated or invalidated, and a field designating the value of N if this function is valid.

Difference address generation unit 22 includes an execution instruction counter 221, a temporary holding count register 222 and a difference address register 223. Difference address generation unit 22 generates a difference address indicating the total number of instructions since a certain sequence change until the next sequence change and outputs the generated difference address to branch source information generation unit 24.

Execution instruction counter 221 is initialized when the sequence change signal is asserted, and is incremented by 2 or 4 in response to the execution instruction size signal if the instruction execution start signal is asserted. Temporary holding count register 222 stores the value of execution instruction counter 221 before being incremented if the instruction execution start signal is asserted.

Difference address register 223 fetches the value of temporary holding count register 222 in response to the instruction execution start signal asserted right after the sequence change signal is asserted and outputs the fetched value to branch source information generation unit 24 as a difference address.

Instruction address register 23 includes an address temporary holding register 231, a branch source address register 232 and a branch destination address register 233 and outputs a branch source address and a branch destination address when a sequence change occurs.

Address temporary holding register 231 stores the execution instruction address outputted from instruction execution unit 6 when the sequence change signal is asserted. Branch source address register 232 stores the value of address temporary holding register 231 in accordance with the instruction execution start signal asserted right after the sequence change signal is asserted and outputs the stored value to branch source information generation unit 24 as a branch source address. Also, branch destination address register 233 stores the execution instruction address outputted from instruction execution unit 6 in accordance with the instruction execution start signal asserted right after the sequence change signal is asserted and outputs the stored execution instruction address to branch destination information generation unit 25 as a branch destination address.

Branch source information generation unit 24 selects whether branch source information is generated using the absolute address of the branch source instruction or using the relative address from a known instruction. If the absolute address is selected, branch source information generation unit 24 generates branch source information in a 32-bit format using the branch source address of 32 bits outputted from branch source address register 232 and outputs the generated branch source information to branch trace information output unit 26.

If the relative address is selected, branch source information generation unit 24 shifts the difference address outputted from execution instruction counter register 223 to the right by one bit, generates branch source information in a four-bit format out of the less significant four bits and outputs the generated branch source information to branch trace information output unit 26. The difference address is shifted to the right by one bit because the minimum unit of an instruction is two bytes and it is necessary to eliminate the unnecessary least significant bit. Basically, if the result of shifting the difference address to the right by one bit shows less than 16, the relative address is selected.

It is noted, however, that if the function of the absolute information mode register is valid and a turn for generating the branch trace information using the absolute address comes (i.e., if an absolute information flag to be described later is set), then the absolute address is selected.

Branch destination information generation unit 25 selects whether branch information is generated using the absolute address of 32 bits or not generated. If the branch information is generated using the absolute address of 32 bits, the branch destination address stored in branch destination address register 233 is used. Basically, if the direct branch signal is asserted, no branch destination information is generated.

However, if the function of the branch destination information mode register is valid and the branch source instruction is within a predetermined range, or if the function of the absolute information mode register is valid and a turn for generating the branch trace information using the absolute address comes, then the branch destination information is generated using the absolute address.

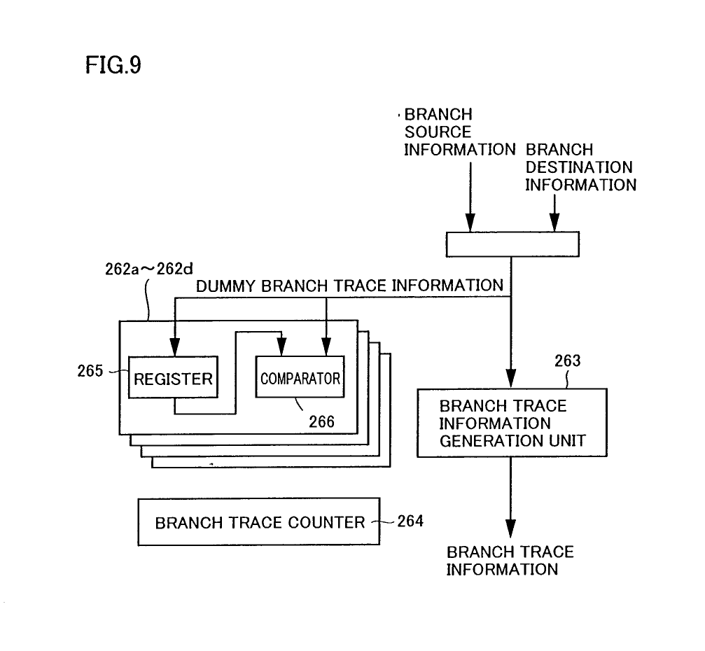

FIG. 9 is a block diagram showing the schematic configuration of branch trace information output unit 26. This branch trace information output unit 26 includes four repeat information registers 262a to 262d, a branch trace information generator 263 and a branch trace counter 264. In addition, each of repeat information registers 262a to 262d includes a register 265 and a comparator 266.

Dummy branch trace information is information generated by combining the branch source information outputted from branch source information generation unit 24 with the branch destination information outputted from branch destination information generation unit 25. If an absolute address is included in either the branch source information or the branch destination information, the dummy branch trace information is applied to four repeat information registers 262a to 262d, respectively and the dummy branch trace information is compared with information held in register 265 in each of repeat information registers 262a to 262d.

If each of the four comparison results shows that the dummy branch trace information is inconsistent with the information held in each register 265, the dummy branch trace information is stored in register 265 in the repeat information register which holds the oldest data. It is noted, however, if input overflow to be described later occurs, the dummy branch trace information is not stored.

Further, if one of the data held in repeat information registers 262a to 262d is coincident with the dummy branch trace information, the dummy branch trace information is stored in the repeat information register having the coincident data. Although the same data is rewritten, data write is purposely performed so as to appropriately control the order of the repeat information registers having data to be rewritten when all the four comparison results show data inconsistency.

Branch trace information generator 263 generates branch trace information and outputs the generated branch trace information to trace information output unit 5 by one of the methods shown in \mathring{1} to \mathring{3} below.

\mathring{1} If branch source information is in a four-bit format and branch destination information is in a 0-bit format, then branch trace information generator 263 outputs the branch source information outputted from branch source information generation unit 24, as branch trace information, to trace information output unit 5. In this case, branch information output unit 5 generates a short branch packet.

\mathring{2} If an absolute address is included in either the branch source information and the branch destination information and one of the data held in four repeat information registers 262a to 262d is consistent with the dummy branch trace information, then branch trace information generator 263 outputs the register number of the repeat information register having the consistent data, as branch trace information, to trace information output unit 5. In this case, trace information output unit 5 generates a repeat branch packet.

\mathring{3} In cases other than \mathring{1} and \mathring{1}, branch trace information generator 263 adds the register number of the repeat information register to which the dummy branch trace information is written to the dummy branch trace information and outputs the register number-added dummy branch trace information, as branch trace information, to trace information output unit 5. In this case, trace information output unit 5 generates a long branch packet.

Branch trace counter 264 updates the value thereof whenever the branch trace information is outputted. If branch trace information generator 263 outputs the branch trace information having both the branch source information and the branch destination information that are indicated by the absolute addresses, branch trace counter 264 is initialized. Otherwise, branch trace counter 264 is incremented. If the outputted branch trace information is lost by input overflow to be described later, however, branch trace counter 264 is neither incremented nor initialized.

If the function of the absolute information mode register in branch trace control unit 21 is valid, the value of branch trace counter 264 is compared with the number “N” of trace information stored in the absolute information mode register. If they are coincident with each other, an absolute information flag, not shown, is set and the branch source information and the branch destination information indicated by the absolute addresses, respectively, are outputted as branch trace information to be outputted next. If the branch source information and the branch destination information indicated by the absolute addresses, respectively, are outputted as branch trace information, the absolute information flag is cleared.

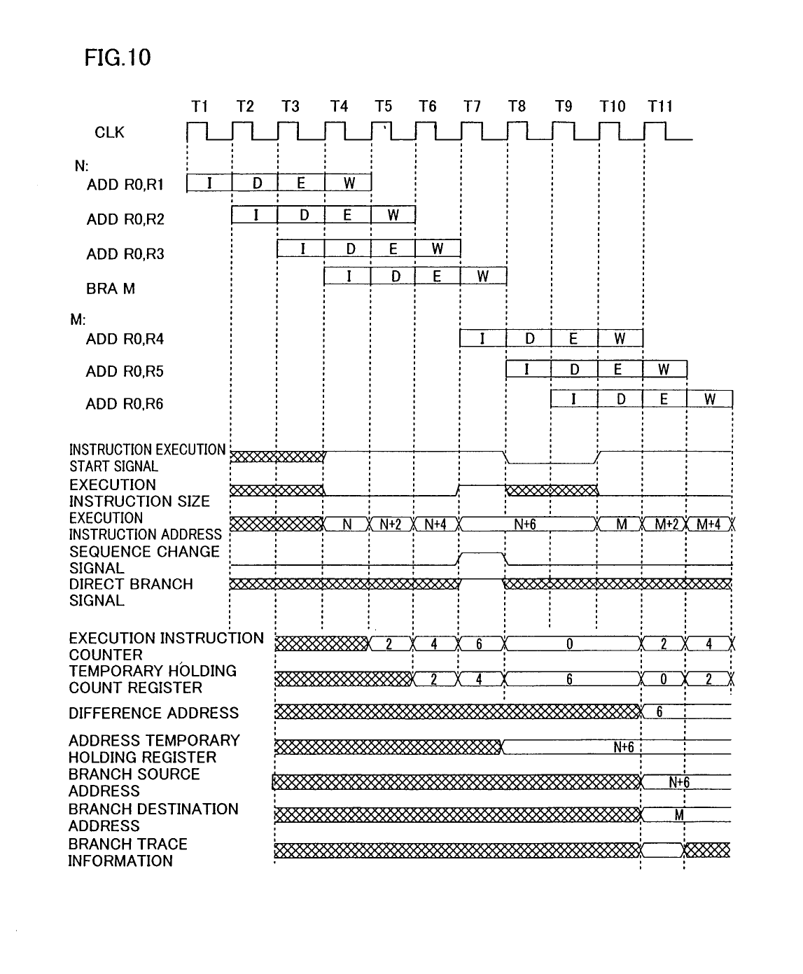

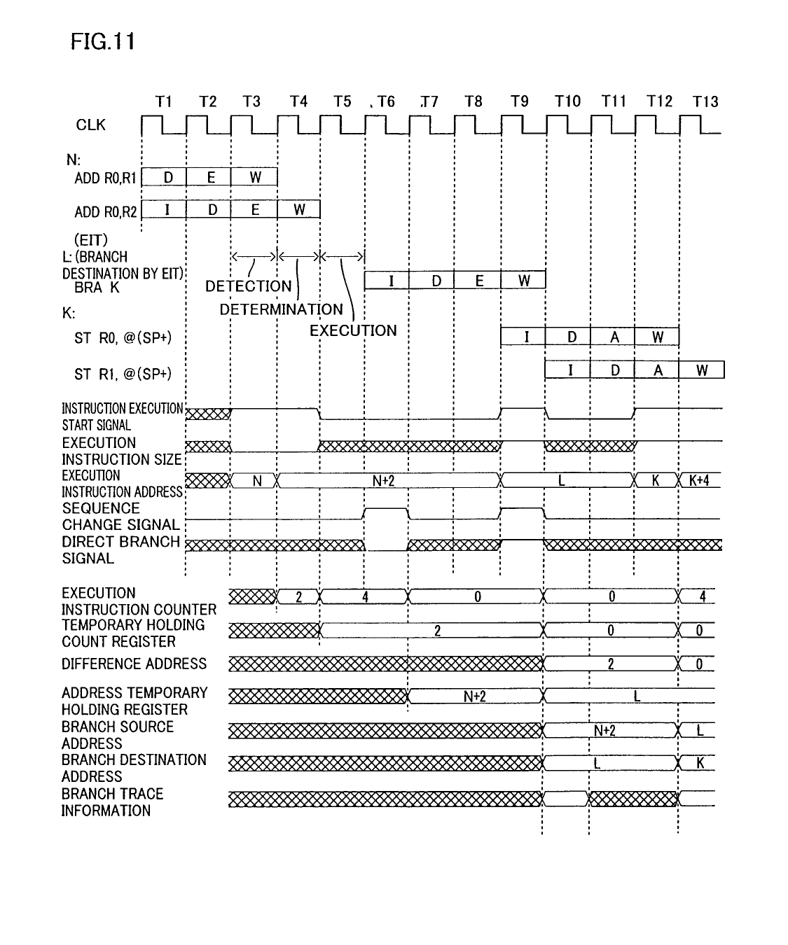

FIG. 10 is a timing chart for respective signals in branch trace information generation unit 2 when ordinary instructions are executed (when instructions are executed in a state in which EIT is not accepted). This timing chart shows timing at which after three ADD instructions are executed, a processing is branched to a label M and three ADD instructions are executed. It is noted that the length of each ADD instruction is two bytes and that of a BRA instruction is four bytes.

If the first ADD instruction is fetched in a cycle T1, the instruction execution start signal is asserted in the W stage of this instruction (T4). At this moment, an execution instruction size and an execution instruction address (N) corresponding to this instruction are outputted.

In a cycle T5, the instruction execution start signal is asserted to correspond to the next ADD instruction. At this moment, the length of the ADD instruction of 2 bytes is added to the execution instruction address and (N+2) is outputted to the execution instruction address. Also, the value of execution instruction counter 221 is incremented by as much as the byte length 2 of the ADD instruction and the counter value turns two.

Likewise, in a cycle T6, the instruction execution start signal is asserted to correspond to the third ADD instruction. At this moment, (N+4) is outputted to the execution instruction address and the counter value of execution instruction counter 221 turns four.

In a cycle T6, if a BRA instruction is executed and a sequence change occurs, then a sequence change signal is asserted in the next W stage (T7). Since the BRA instruction is a direct branch instruction, a direct branch signal is asserted in cycle T7, as well. In this cycle, the ADD instruction which is a branch destination instruction is fetched.

In a cycle T8, execution instruction counter 221 is initialized. At this moment, temporary holding count register 222 stores the value 6 of execution counter 221 in cycle T7. Also, address temporary holding register 231 stores the execution instruction address value of N+6.

In the W stage of the ADD instruction which is the branch destination instruction, the instruction execution start signal is asserted again (T10). At this moment, an execution instruction size and an execution instruction address (M) corresponding to this branch destination instruction are outputted.

In a cycle T11, if the instruction execution start signal is asserted to correspond to the next ADD instruction which is a branch destination instruction, difference address register 223 fetches the value 6 of temporary holding count register 222 and outputs the fetched value 6 as a difference address. At this moment, branch source address register 232 stores the value (N+6) of address temporary holding register 231. Branch destination address register 233 stores the execution instruction address value M. Branch trace information generation unit 2 generates branch trace information from the branch source address stored in branch source address register 232 and the branch destination address stored in branch destination address register 233 and outputs the generated branch trace information.

FIG. 11 is a timing chart for respective signals in branch trace information generation unit 2 when EIT is accepted. This timing chart shows timing at which EIT is accepted after two ADD instructions are executed and a BRA instruction which is a branch destination instruction is executed. It is noted that symbol SP+ used in an ST instruction represents that data is written to the memory with a stack pointer set as an address and that the value of the stack pointer is incremented by four.

If EIT is detected in a cycle T3, the execution of instructions after the second ADD instruction is not started. In a cycle T4, the determination of EIT is conducted to determine which request is to be accepted. In a cycle T5, a jump to an instruction address value L corresponding to the accepted EIT is executed.

In a cycle T6, the sequence change signal is asserted. In cycle T6, the BRA instruction which is a branch destination instruction is fetched. Since the jump corresponding to EIT is not direct branch, the direct branch signal is not asserted.

In a cycle T7, execution instruction counter 221 is initialized. At this moment, address temporary holding register 231 stores the execution instruction address value of N+2.

If the BRA instruction is executed and a sequence change occurs in a cycle T8, then the sequence change signal is asserted in the next W stage (T9). Since the BRA instruction is a direct branch instruction, the direct branch signal is asserted in cycle T9. In this cycle, an ST instruction which is a branch destination instruction is fetched.

If the instruction execution start signal is asserted to correspond to the BRA instruction, difference address register 223 fetches the value of temporary holding count register 222 and outputs the fetched value as a difference address in a cycle T10. At this moment, branch source address register 232 stores the value N+2 of address temporary holding register 212. Branch destination address register 233 stores the execution instruction address value L. Branch trace information generation unit 2 generates branch trace information from the branch source address stored in branch source address register 232 and the branch destination address stored in branch destination address register 233 and outputs the generated branch trace information.

In the M stage of the ST instruction which is the branch destination information, the instruction execution start signal is reasserted (T12). At this moment, an execution instruction size and an execution instruction address (K) corresponding to this branch destination information are outputted.

In a cycle T13, if the instruction execution start signal is asserted to correspond to the next ST instruction which is a branch destination instruction, difference address register 223 fetches the value 0 of temporary holding count register 222 and outputs the fetched value as a difference address. At this moment, branch source address register 232 stores the value L of address temporary holding register 231. Branch destination address register 233 stores an execution instruction address value K. Branch trace information generation unit 2 generates branch trace information from the branch source address stored in branch source address register 232 and the branch destination address stored in branch destination address register 233 and outputs the generated branch trace information.

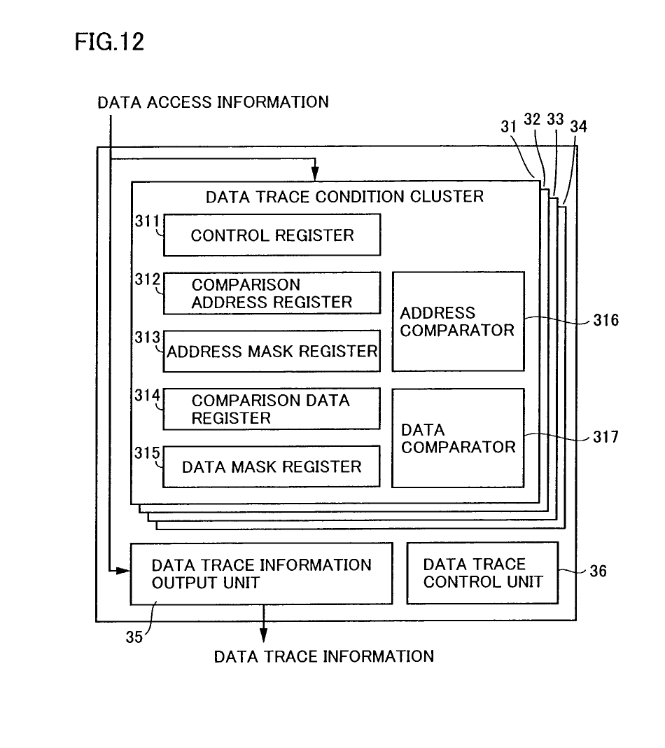

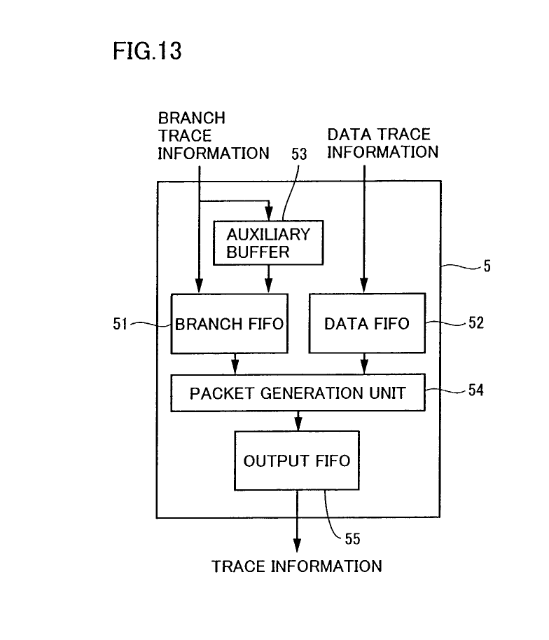

FIG. 12 is a block diagram showing the schematic configuration of data trace information generation unit 3. This data trace information generation unit 3 includes data trace condition clusters 31 to 34, a data trace information output unit 35 generating data trace information from data access information and a data trace control unit 36 controlling overall data trace information generation unit 35.

Each of data trace condition clusters 31 to 34 designates a data trace condition and includes a control register 311, a comparison address register 312, an address mask register 313, a comparison data register 314, a data mask register 315, an address comparator 316 and a data comparator 317. These registers are accessible from external equipment through JTAG (Joint Test Action Group) circuit.

While the data trace conditions are set in data trace condition clusters 31 to 34, respectively, data trace condition clusters 31 to 34 can set the data trace conditions independently of one another. If operand access coincides with the condition set in one or more data trace condition clusters, it is determined that the data trace condition is satisfied.

Control register 311 has not only an enable bit showing whether or not a data trace condition is designated but also a field designating a target access mode and the size of target access for write access. As the target access mode, a read only mode, a write only mode or a read and write mode is designated. As the access size, only one-byte access, only two-byte access or only four-byte access is designated.

Control register 311 has also a field designating whether a short format packet is generated, a long format packet is generated or a mixed format packet is generated if operand access coincides with the condition set in one of the data trace condition clusters.

A target operand address is designated in comparison address register 312 and address mask register 313, respectively. Address comparator 316 compares the content of comparison address register 312 with the operand address included in data access information. At this moment, address mask register 313 designates a comparison target address bit.

If all the address bits are to be compared, for example, the operand address is to be traced only if the operand address completely coincides with the content of comparison address register 312. If all the address bits are excluded from a comparison target, the operand address is not to be traced. Also, if only a few bits from the least significant bit are excluded from the comparison target, the operand address only in a specific address range is to be traced.

Target operand data is designated in comparison data register 314 and data mask register 315, respectively. Data comparator 317 compares the content of comparison data register 314 with operand data included in data access information. At this moment, data mask register 315 designates a target data bit.

If all the data bits are to be compared, for example, the operand data is to be traced only when the operand data completely coincides with the content of comparison data register 314. If all the data bits are excluded from the comparison target, the operand data is not to be traced. Also, if only a specific bit is designated as the comparison target, it is possible to set trace conditions consistent with a purpose.

In each of data trace condition clusters 31 to 34, only if address comparator 316 determines that the operand address coincides with the content of comparison address register 312 and data comparator 317 determines that the operand data coincides with the content of comparison data register 314, it is determined that the operand access coincides with the trace condition.

Data trace information output unit 35 generates data trace information from the operand access determined to coincide with the trace condition and outputs the generated data trace information to trace information output unit 5. Data trace information output unit 35 encodes a predetermined bit of the data access information and thereby generates a part corresponding to the access condition. Data trace information output unit 35 also adds the information generated by the following \mathring{1} to \mathring{3} to the data trace information and outputs the resultant data trace information.

\mathring{1} If the data trace condition clusters storing the coincident trace condition include a cluster which designates a mixed format, address information of 32 bits, data information of 32 bits and an instruction address field of 32 bits are extracted from the data access information.

\mathring{2} In cases other than \mathring{1} above and where the data trace condition clusters storing the coincident trace condition include a cluster which designates a long format, address information of 32 bits and data information of 32 bits are extracted from the data access information.

\mathring{3} In cases other than \mathring{1} and \mathring{2} above, i.e., if all the data trace condition clusters storing the coincident trace condition designate a short format, a condition cluster number is generated from the cluster number of the coincident trace condition and address information is generated from the less significant 14 bits of the address of the data access information. If the trace condition set in a plurality of data trace condition clusters coincides with operand access, the lowest cluster number is selected. It is noted that the cluster numbers of data trace condition clusters 31 to 34 are #0 to #3, respectively.

FIG. 13 is a block diagram showing the schematic configuration of trace information output unit 5. This trace information output unit 5 includes a branch FIFO 51, a data FIFO 52, an auxiliary buffer 53, a packet generation unit 54 and an output FIFO 55.

If the auxiliary trace enable is set in the branch trace enable register, the branch trace information outputted from branch trace information generation unit 2 is stored in auxiliary buffer 53. The branch trace information stored in auxiliary buffer 53 is transferred to branch FIFO 51 when the data trace information is transferred to data FIFO 52. It is the branch trace information satisfying the following \mathring{1} or \mathring{2} condition that is transferred to branch FIFO 51.

\mathring{1} Branch trace information which has been stored in auxiliary buffer 53 when new data trace information is transferred to data FIFO 52.

\mathring{2} Branch trace information stored in auxiliary buffer 53 simultaneously with the transfer of new data trace information to data FIFO 52 or a piece of branch trace information stored in auxiliary buffer 53 after the data trace information is transferred to data FIFO 52.

If the next branch trace information is transferred to auxiliary buffer 53 before the information satisfies the condition \mathring{1} or \mathring{2}, the next branch trace information is overwritten on the content of auxiliary buffer 53. As a result, only two piece of branch trace information before and after the data trace information, respectively, are transferred to branch FIFO 51.

If the branch enable is set in the branch trace enable register, the branch trace information is directly stored in branch FIFO 51 without using auxiliary buffer 53. It is noted that the data trace information outputted from data trace information generation unit 3 is always stored in data FIFO 52.

Packet generation unit 54 generates trace packet shown in FIGS. 2A to 2F from the branch trace information stored in branch FIFO 51 and the data trace information stored in data FIFO 52. After the trace information generated by packet generation unit 54 is temporarily stored in output FIFO 55, the trace information is divided into pieces of data according to the number of pins used for the output of the trance information and outputted as the trace information. In this embodiment, eight pins are used for the output of the trace information. If both branch FIFO 51 and data FIFO 52 include data, packet generation unit 54 may appropriately read data from one of the FIFO's and generate trace information. It is noted that round robin scheduling having the following priority levels is adopted in this embodiment.

Branch FIFO 51>Data FIFO 52

If the capacity of either branch FIFO 51 or data FIFO 52 is full and the next branch trace information or data trace information is transferred to branch FIFO 51 or data FIFO 52, the transferred branch trace information or data trace information is lost. This phenomenon will be referred to as “input overflow” hereinafter. If input overflow occurs, branch FIFO 51 or data FIFO 52 sets an input overflow flag to the branch trace information or data trace information transferred first after the input overflow occurs.

Packet generation unit 54 sets an overflow flag to the generated trace packet if the input overflow flag is set to the read data. If the capacity of output FIFO 55 is full, packet generation unit 54 does not read data from branch FIFO 51 and data FIFO 52.

In this embodiment, the branch destination information is omitted from the branch trace packet during direct branch so as to reduce the amount of data. However, if branch is direct branch having no conditions, it is obvious that data is branched. In this case, therefore, by preventing branch trace information generation unit 2 from generating branch trace information itself so as not to generate branch trace packets, it is possible to further reduce the amount of data.

Furthermore, two branch packets are generated before and after the data trace information, respectively by storing the branch trace information in auxiliary buffer 53 in this embodiment. It is also possible to generate only one branch packet before the data trace information or after the data trace information. It is also possible to output N pieces of data trace information and then output M pieces of branch trace information. These methods can be easily realized by providing trace information output unit 5 with a counter counting the data trace information and branch trace information.

Furthermore, the timing at which all the data trace information is transferred is used as a trigger for generating branch packets in this embodiment. Alternatively, if each of data trace condition clusters 31 to 34 is provided with, for example, a register designating whether or not auxiliary trace is started and the auxiliary trace is started only when the data trace information satisfies the condition, then it is possible to output only the branch trace information corresponding to specific data trace information.

As stated so far, according to the trace information generation apparatus in the first embodiment, if direct branch in which a branch destination is explicitly shown in a program or the like is performed, the branch destination information is omitted from branch packets. This makes it possible to compress the branch trace information and to decrease the amount of data.

It is noted, however, that there is a probability that the content of a region showing the branch destination in the program is rewritten. Due to this, even if direct branch is performed, branch destination information generated as the absolute address is included in a branch packet for a predetermined address region. By doing so, it is possible to make flexible settings of including the branch destination information in the branch packet even in case of direct branch if a RAM region in which a program is likely to be rewritten is the branch destination and omitting the branch destination information if a ROM region in which a program is unlikely to be rewritten is the branch destination.

Furthermore, since the branch source information on the branch trace information can be denoted by the relative address from the branch destination instruction designated by the branch trace information just before the branch trace information, it is possible to compress the branch trace information and to further decrease the amount of data.

Moreover, the branch trace information generated as the absolute address is always outputted whenever the branch trace information is outputted a predetermined number of times. Due to this, even if the capacity of the branch trace information exceeds the capacity of the trace memory and old information is lost, it is possible to restore correct instruction execution based on the branch trace information generated as the absolute address.

Furthermore, if the same branch processing is repeated and the same branch information is outputted a number of times like a loop processing, the branch destination information and the branch source information are omitted and the repeat branch packet is outputted. It is, therefore, possible to compress the branch trace information and to further decrease the amount of data.

Also, since the instruction address of the instruction for starting operand access is included in the data packet, it is possible to specify which instruction in the program executes the noted operand access.

Additionally, since the branch trace information is generated by a predetermined number of times with the occurrence of noted operand access as a trigger, it is possible to specify which instruction in the program executes the noted operand access.

(Second Embodiment)

A debugging device in a second embodiment according to the present invention differs from the debugging device in the first embodiment only in that the function of instruction execution information generation unit 65 shown in FIG. 6 differs. Accordingly, the detailed description of the same constituent elements and functions will not be repeated herein. It is noted that description will be given while using a reference symbol 65′ for denoting the instruction execution information generation unit in the second embodiment.

Instruction execution information generation unit 65 in the first embodiment allows direct branch only if the branch destination is explicit in the program. Instruction execution information generation unit 65′ in the second embodiment, by contrast, allows direct branch in case of the following \mathring{1} or \mathring{2} to thereby further compress branch packet data.

\mathring{1} In a return instruction for returning from a subroutine call, if no data is written to a link register storing a return destination address since the execution of a subroutine call instruction until the execution of the return instruction, the return instruction is dealt with as an direct branch instruction.

CPU 61 outputs a signal showing the execution of the subroutine call instruction, a signal showing the execution of the return instruction and a signal showing the execution of an instruction for writing a value to the link register. These signals can be easily generated from instruction decoding results.

Instruction execution information generation unit 65′ has a flag which is set if the subroutine call instruction is executed and which is cleared if the instruction for writing a value to the link register is executed. Instruction execution information generation unit 65′ outputs a direct branch signal simultaneously with the output of a sequence change signal corresponding to the return instruction if this flag is set when the return instruction is executed.

\mathring{1} In a return interrupt instruction for returning from an interrupt, if no data is written to a backup PC register storing a return destination address since the occurrence of the interrupt until the execution of the return interruption instruction, the return interruption instruction is dealt with as a direct branch instruction.

CPU 61 outputs a signal showing the occurrence of an interrupt, a signal showing the execution of the return interrupt instruction and a signal showing the execution of an instruction for writing a value to the backup PC register. These signals can be easily generated from instruction decoding results.

Instruction execution information generation unit 65′ has a flag which is set if an interrupt occurs and which is cleared if the instruction for writing a value in the backup PC register is executed. Instruction execution information generation unit 65′ outputs a direct branch signal simultaneously with the output of a sequence change signal corresponding to the return interrupt instruction if this flag is set when the return interrupt instruction is executed.

As stated so far, according to the debugging device in the second embodiment, by dealing with instructions satisfying predetermined conditions as direct branch instructions, it is possible to further compress data and to further decrease the amount of data of trace information.

It should be understood that the embodiments disclosed herein are provided only for illustrative purposes and do not limit the invention. The scope of the present invention is defined not by the description given above but claims which follow and all changes and modifications within the scope of the claims and the meaning and range of equivalence are intended to be encompassed by the present invention.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A trace information generation apparatus comprising:
a branch trace information generation unit generating branch trace information omitting at least part of branch source information and branch destination information on a target processing based on instruction execution information showing an instruction execution status of a processor; and
a trace information output unit generating and outputting trace information capable of restoring instructions executed by said processor from the branch trace information generated by said branch trace information generation unit.

2. The trace information generation apparatus according to claim 1, wherein
said branch trace information generation unit generates the branch trace information omitting the branch destination information if said target processing is a direct branch for which a branch destination is explicitly described in a program.

3. The trace information generation apparatus according to claim 2, wherein
said branch trace information generation unit regards an instruction for returning to a processing corresponding to a program counter value saved in a predetermined register as a direct branch instruction and generates the branch trace information, if a series of processings occurs for returning to the processing corresponding to the program counter value after saving the program counter value in said predetermined register, branching and carrying out a predetermined processing, and if no other data are written to said predetermined register since said program counter value is saved in said predetermined register until the instruction for returning to the processing corresponding to the program counter value is executed.

4. The trace information generation apparatus according to claim 1, wherein
said branch trace information generation unit omits generating the branch trace information if said target processing is a direct branch for which a branch destination is explicitly described in a program and an unconditional branch.

5. The trace information generation apparatus according to claim 1, further comprising a register designating whether to omit the branch destination information, wherein
said branch trace information generation unit generates the branch trace information omitting the branch destination information if said target processing is a direct branch for which a branch destination is explicitly described in a program and said register designates omission of the branch destination, and generates the branch trace information including the branch destination information if said target processing is the direct branch and said register designates non-omission of the branch destination.

6. The trace information generation apparatus according to claim 1, further comprising a register designating whether to omit the branch destination information for each address region, wherein
said branch trace information generation unit generates the branch trace information omitting the branch destination information if said target processing is a direct branch for which a branch destination is explicitly described in a program and said register designates omission of the branch destination, and generates the branch trace information including the branch destination information if said target processing is the direct branch and a content of said register corresponding to an address of a branch source is to designate non-omission of the branch destination.

7. The trace information generation apparatus according to claim 1, wherein
said branch trace information generation unit generates the branch source information as a relative address from the branch destination information included in previously generated branch trace information, and generates the branch trace information including the branch source information.

8. The trace information generation apparatus according to claim 7, wherein
said branch trace information generation unit generates the branch trace information including the branch source information generated as an absolute address every time the branch trace information including the branch source information generated as a relative address is generated a predetermined number of times.

9. The trace information generation apparatus according to claim 1, wherein
said branch trace information generation unit generates the branch trace information including information designating previously generated branch trace information and omitting the branch source information and the branch destination information if the branch trace information on said target processing is consistent with said previously generated branch trace information.

10. The trace information generation apparatus according to claim 9, wherein
said branch trace information generation unit includes a plurality of history holding registers each having a unique register number and holding the previously generated branch trace information;
said branch trace information generation unit generates a packet including the register number of the history holding register and outputs the generated packet as the branch trace information, if the branch trace information on said target processing coincides with one of the branch trace information held by said plurality of history holding registers, and
updates a content of one of said plurality of history holding registers by the branch trace information, generates a packet including the branch trace information and the register number of the history holding register and outputs the generated packet as the branch trace information, if the branch trace information on said target processing does not coincide with any branch trace information held by said plurality of history holding registers.

11. The trace information generation apparatus according to claim 1, further comprising a data trace condition cluster setting a data trace condition; and
a data trace information generation unit generating data trace information showing data access executed by said processor if data access information showing a data access status of said processor coincides with the data trace condition set by said data trace condition cluster, wherein
said trace information output unit generates and outputs the trace information from the data trace information generated by said data trace information generation unit.

12. The trace information generation apparatus according to claim 11, wherein
said data trace information generation unit generates data trace information including an address of an instruction starting operand access coincident with the data trace condition set by said data trace condition cluster.

13. The trace information generation apparatus according to claim 11, wherein
said trace information output unit selectively generates and outputs the trace information from the branch trace information generated by said branch trace information generation unit with reference to a point at which the data trace information is generated by said data trace information generation unit.

14. The trace information generation apparatus according to claim 11, wherein
said trace information output unit selectively generates and outputs the trace information from the branch trace information generated by said branch trace information generation unit with reference to a point at which the data trace information is generated, if the data trace information generated by said data trace information generation unit is an operand access designated in advance.
